(19) United States
(12) Patent Application Publication
(10) Pub. No.: US 2023/0008780 A1
(43) Pub. Date: Jan. 12, 2023

(54) FUNCTIONALLY GRADED ADDITIVELY MANUFACTURED PARTS FOR BUMP, SQUEAK, RATTLE MITIGATION

(71) Applicant: Ford Motor Company, Dearborn, MI (US)

(72) Inventors: Siddharthan Selvasekar, Livermore, CA (US); Michael Steven Medoro, Sunnyvale, CA (US); Christopher Contiliano, Detroit, MI (US); Dylan Mandelbaum, Mountain View, CA (US); Andres Almeida Senatore, San Jose, CA (US)

(73) Assignee: Ford Motor Company, Dearborn, MI (US)

(21) Appl. No.: 17/369,579

(22) Filed: Jul. 7, 2021

(51) Int. Cl. B60R 13/08; B33Y 80/00; B33Y 10/00; B33Y 30/00; B29C 64/118; B29C 64/129

(52) U.S. Cl. CPC B60R 13/0815; B33Y 80/00; B33Y 10/00; B33Y 30/00; B29C 64/118; B29C 64/129; B29C 64/112

(57) ABSTRACT

A method of manufacturing a component includes additively manufacturing (AM) a plurality of interior layers of the component and AM at least one anti-bump, squeak, rattle (BSR) layer of the component such that the at least one anti-BSR layer reduces BSR acoustic noise compared to the plurality of interior layers. The at least one anti-BSR layer can be a plurality of anti-BSR layers and the plurality of anti-BSR layers includes a BSR property that is different than a corresponding BSR property of the plurality of interior layers.

### FIELD

The present disclosure relates to additively manufactured parts and particularly to additively manufactured parts for use in bump, squeak, rattle applications.

### BACKGROUND

The statements in this section merely provide background information related to the present disclosure and may not constitute prior art.

Bump, squeak, rattle (BSR), also known as buzz-squeak-rattle, occurs between at least two parts or components of a device or machine that bump and/or rub against each other such that an acoustic sound is produced during operation or use of the device or machine. And if/when the acoustic sound is loud enough to be heard by a user or occupant of the device, such an acoustic sound can be undesirable.

In the automotive industry, among others, foam and/or felt tape is often placed in locations between two or more components where BSR is observed and/or known to be a problem. However, the use of such foam and/or felt tape in “BSR applications” results in an extra manufacturing step during assembly of a vehicle. In addition, such foam and/or felt tape is generally required to meet one or more flammability resistance standards (e.g., FMVSS 302) which adds to the cost of the material.

The present disclosure addresses the issues of mitigating BSR and other issues related to BSR.

### SUMMARY

This section provides a general summary of the disclosure and is not a comprehensive disclosure of its full scope or all of its features.

In one form of the present disclosure, a method of manufacturing a component includes additively manufacturing (AM) a plurality of interior layers of the component and AM at least one anti-BSR layer of the component such that the at least one anti-BSR layer is configured to reduce BSR acoustic noise compared to the plurality of interior layers.

In some variations, the at least one anti-BSR layer is a plurality of anti-BSR layers, and the plurality of anti-BSR layers includes a BSR property that is different (i.e., has a different value) than a corresponding BSR property of the plurality of interior layers. In such variations, the BSR property of the plurality of anti-BSR layers is generally uniform across the plurality of anti-BSR layers, or in the alternative, the BSR property of the plurality of anti-BSR layers is functionally graded across the plurality of anti-BSR layers. In some variations, the BSR property of the plurality of anti-BSR layers and the corresponding BSR property of the plurality of interior layers is selected from the group consisting of strength, ductility, hardness, elastic modulus, coefficient of friction, and density. For example, in at least one variation the at least one anti-BSR layer has a first ductility, the plurality of interior layers have a second ductility less than the first ductility, and the at least one anti-BSR layer is configured as an anti-bump and anti-rattle layer. While in another variation, the at least one anti-BSR layer has a first coefficient of friction, the plurality of interior layers have a second ductility greater than the first coefficient of friction, and the at least one anti-BSR layer is configured as an anti-squeak layer.

In some variations, the plurality of interior layers of the component and the at least one anti-BSR layer are multi jet fusion (MJF) additive manufactured layers and the at least one anti-BSR layer receives less thermal exposure than the plurality of interior layers during MJF AM of the component such that the at least one anti-BSR layer has a BSR property different than a corresponding BSR property of the plurality of interior layers. And in such variations, the BSR property of the at least one anti-BSR layer and the corresponding BSR property of the plurality of interior layers is selected from the group consisting of strength, ductility, hardness, elastic modulus, coefficient of friction, and density. For example, in at least one variation the at least one anti-BSR layer has a first ductility, the plurality of interior layers have a second ductility less than the first ductility, and the at least one anti-BSR layer is configured as an anti-bump and anti-rattle layer. While in another variation, the at least one anti-BSR layer has a first coefficient of friction, the plurality of interior layers have a second ductility greater than the first coefficient of friction, and the at least one anti-BSR layer is configured as an anti-squeak layer.

In other variations, the plurality of interior layers and the at least one anti-BSR layer are selective laser sintering (SLS) additive manufactured layers and the at least one anti-BSR layer is formed with less laser power than the plurality of interior layers during SLS AM of the component such that the at least one anti-BSR layer comprises a BSR property different than a corresponding BSR property of the plurality of interior layers. And in such variations the BSR property of the at least one anti-BSR layer and the corresponding BSR property of the plurality of interior layers is selected from the group consisting of strength, ductility, hardness, elastic modulus, coefficient of friction, and density. For example, in at least one variation the at least one anti-BSR layer has a first ductility, the plurality of interior layers have a second ductility less than the first ductility, and the at least one anti-BSR layer is configured as an anti-bump and anti-rattle layer. While in another variation, the at least one anti-BSR layer has a first coefficient of friction, the plurality of interior layers have a second ductility greater than the first coefficient of friction, and the at least one anti-BSR layer is configured as an anti-squeak layer.

In still other variations, the plurality of interior layers and the at least one anti-BSR layer is additively manufactured via continuous liquid interface production (CLIP), stereolithography (SLA) or digital light processing (DLP), and the at least one anti-BSR layer is formed with less ultraviolet energy than the plurality of interior layers during CLIP, SLA or DLP AM of the component such that the at least one anti-BSR layer comprises a BSR property different than a corresponding BSR property of the plurality of interior layers. And in such variations the BSR property of the at least one anti-BSR layer and the corresponding BSR property of the plurality of interior layers is selected from the group consisting of strength, ductility, hardness, elastic modulus, and coefficient of friction. For example, in at least one variation the at least one anti-BSR layer has a first ductility, the plurality of interior layers have a second ductility less than the first ductility, and the at least one anti-BSR layer is configured as an anti-bump and anti-rattle layer. While in another variation, the at least one anti-BSR layer has a first coefficient of friction, the plurality of interior layers have a second ductility greater than the first coefficient of friction, and the at least one anti-BSR layer is configured as an anti-squeak layer.

In some variations, the plurality of interior layers and the at least one anti-BSR layer is additively manufactured via fused filament fabrication (FFF) and the at least one anti-BSR layer is formed with a different extruded temperature, cooling rate, bead width and/or bead contour than the plurality of interior layers during FFF AM of the component such that the at least one anti-BSR layer comprises a BSR property different than a corresponding BSR property of the plurality of interior layers. And in such variations the BSR property of the at least one anti-BSR layer and the corresponding BSR property of the plurality of interior layers is selected from the group consisting of strength, ductility, hardness, elastic modulus, coefficient of friction, and density. For example, in at least one variation the at least one anti-BSR layer has a first ductility, the plurality of interior layers have a second ductility less than the first ductility, and the at least one anti-BSR layer is configured as an anti-bump and anti-rattle layer. While in another variation, the at least one anti-BSR layer has a first coefficient of friction, the plurality of interior layers have a second ductility greater than the first coefficient of friction, and the at least one anti-BSR layer is configured as an anti-squeak layer.

In another form of the present disclosure, a method of manufacturing a component includes AM a plurality of interior layers of the component and AM a plurality of anti-BSR layers of the component such that the plurality of anti-BSR layers have a BSR property different than a corresponding BSR property of the plurality of interior layers and the plurality of anti-BSR layers are configured to reduce BSR acoustic noise compared to the plurality of interior layers.

For example, in some variations the plurality of anti-BSR layers have a first ductility greater, the plurality of interior layers have a second ductility less than the first ductility, and the plurality of anti-BSR layers is configured as an anti-bump and anti-rattle layer. While in other variations the plurality of anti-BSR layers have a first coefficient of friction, the plurality of interior layers have a second coefficient of friction greater than the first coefficient of friction, and the plurality of anti-BSR layers are configured as an anti-squeak layer.

In still another form of the present disclosure, a method of manufacturing a component includes AM a plurality of interior layers of the component and AM a plurality of anti-BSR layers of the component such that the plurality of anti-BSR layers have a BSR property different than a corresponding BSR property of the plurality of interior layers and the plurality of anti-BSR layers are configured to reduce BSR acoustic noise compared to the plurality of interior layers. Also, the BSR property of the plurality of anti-BSR layers and the corresponding BSR property of the plurality of interior layers is selected from the group consisting of strength, ductility, hardness, elastic modulus, coefficient of friction, and density.

In some variations, the plurality of anti-BSR layers is formed with at least one of less ultraviolet energy, less thermal exposure, and less laser power than the plurality of interior layers.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A shows a first component moving towards a second component in a bump BSR application;

FIG. 1B shows the first component impacting the second component and producing a bump acoustic noise;

FIG. 2A shows a first component in contact with a second component in a squeak BSR application;

FIG. 2B shows the first component sliding relative to the second component and producing a squeak acoustic noise;

FIG. 3A shows a first component moving towards a second component in a rattle BSR application;

FIG. 3B shows the first component repeatably impacting the second component and producing a rattle acoustic noise;

FIG. 4A shows a cross-section of a first component with a single anti-BSR layer according to one form of the present disclosure;

FIG. 4B shows a cross-section of a first component with a plurality of anti-BSR layers according to another form of the present disclosure;

FIG. 4C shows a cross-section of a first component with a plurality of anti-BSR layers according to still another form of the present disclosure;

FIG. 5A shows a cross-section of a first component with a single anti-BSR layer having anti-BSR geometric features according to one form of the present disclosure;

FIG. 5B shows a cross-section of a first component with a plurality of anti-BSR layers and at least one of the anti-BSR layers having anti-BSR geometric features according to another form of the present disclosure;

FIG. 5C shows a cross-section of a first component with a plurality of anti-BSR layers and at least one of the anti-BSR layers having anti-BSR geometric features according to still another form of the present disclosure;

FIG. 6A shows a cross-section of a first component with an anti-BSR layer in use with a second component made with a traditional manufacturing process according to the teachings of the present disclosure;

FIG. 6B shows a cross-section of a first component with an anti-BSR layer in use with a second component made with an additive manufacturing process according to the teachings of the present disclosure;

FIG. 6C shows a cross-section of a first component with an anti-BSR layer in use with a second component with an anti-BSR layer according to the teachings of the present disclosure;

FIG. 7A shows a BSR application with a headrest and a pair of headrest supports;

FIG. 7B shows an enlarged cross-sectional view of section 7B in FIG. 7A;

FIG. 7C shows a cross-sectional view of section 7C-7C in FIG. 7A according to one form of the present disclosure;

FIG. 7D shows a cross-sectional view of section 7D-7D in FIG. 7A according to another form of the present disclosure;

FIG. 8 is a flow chart of a method for manufacturing a component according to one form of the present disclosure; and

FIG. 9 is a flow chart of a method for manufacturing a component according to another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

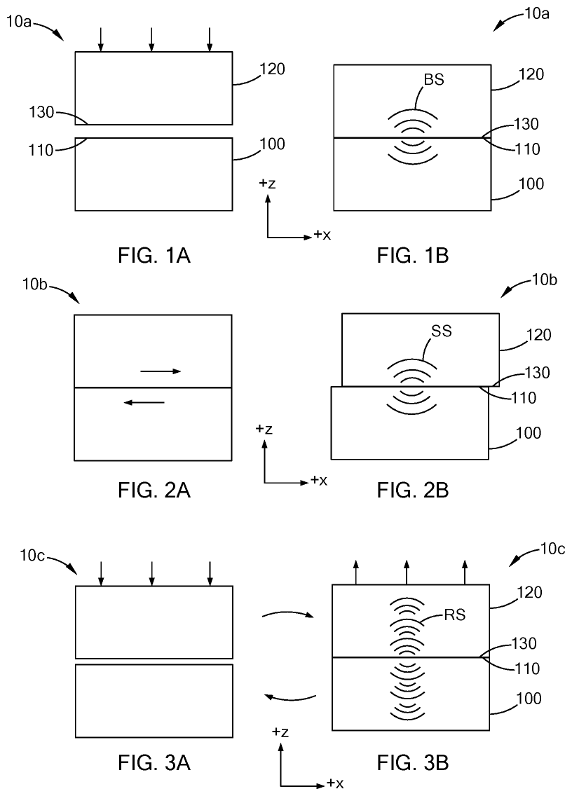

Referring to FIGS. 1A-1B, two components in a ‘bump’ BSR application 10a are shown. Particularly, a first component 100 with a surface 110 is in close proximity to and moving towards a second component 120 with a surface 130 as shown in FIG. 1A. In FIG. 1B, the surfaces 110, 130 come into contact with each other and thereby produce or result in a bump acoustic sound ‘BS’. As used herein, the phrase “BSR application” refers to an operation of a device or machine that results in at least two components of the device or machine moving relative to each other such that a BSR acoustic noise is produced.

Referring to FIGS. 2A-2B, the two components 100, 120 in a ‘squeak’ BSR application 10b are shown. Particularly, the first surface 110 of the first component 100 is in contact with the surface 130 of second component 120 as shown in FIG. 2A.

And in FIG. 2B, the two surfaces 110, 130 move or slide relative to each other and thereby produce or result in a squeak acoustic sound ‘SS’.

Referring to FIGS. 3A-3B, the two components 100, 120 in a ‘rattle’ BSR application 10c are shown. Particularly, a repeated cycle of the first surface 110 of the first component 100 moving towards and impacting the surface 130 of the second component 120 is shown. Stated differently, the surfaces 110, 130 move back and forth (+/−z directions) relative to each such that the surfaces 110, 130 repeatably come into contact with each other and thereby produce or result in a rattle acoustic sound ‘RS’.

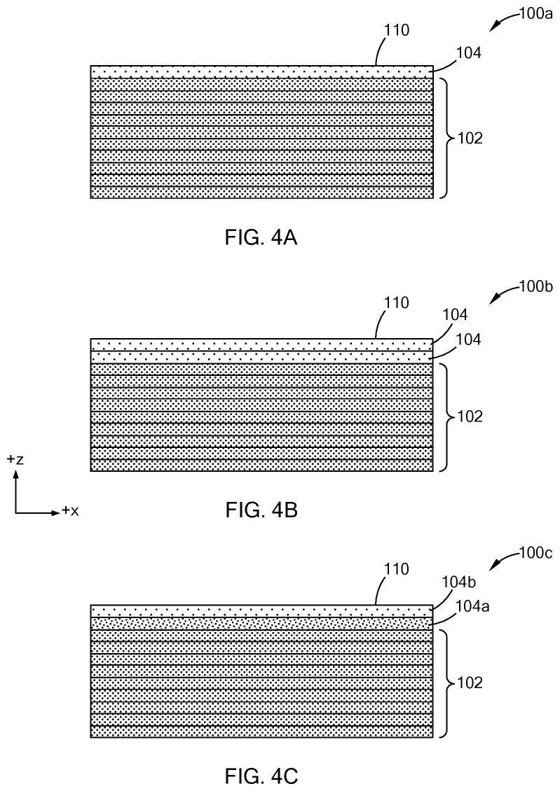

Referring now to FIGS. 4A-4C, components with at least one anti-BSR layer configured to reduce BSR acoustic noise according to the teachings of the present disclosure are shown. For example, In FIG. 4A a first component 100a includes a plurality of additively manufactured interior layers 102 and an additively manufactured anti-BSR layer 104 that includes the first surface 110. As used herein, the phrase “anti-BSR layer” refers to a layer of a part or component (simply referred to herein as “component”) with at least one BSR property that decreases BSR acoustic noise in a BSR application compared to a plurality of interior layers of the component. Stated differently, but for the anti-BSR layer, use of the component in a BSR application results in undesirable BSR acoustic noise.

Non-limiting examples of a BSR property include yield strength, ultimate tensile strength (also known as “tensile strength”), ductility, hardness, elastic modulus, coefficient of friction, and density, among others.

In some variations, each of the plurality of additively manufactured interior layers 102 have a BSR property and the at least one additively manufactured anti-BSR layer 104 has a corresponding BSR property that is not equal to the BSR property of the plurality of additively manufactured interior layers 102. And in at least one variation, the plurality of additively manufactured interior layers 102 as a whole (i.e., an average) have a BSR property and the additively manufactured anti-BSR layer 104 has a corresponding BSR property that is not equal to the average BSR property of the plurality of additively manufactured interior layers 102.

It should be understood that comparison of a BSR property of one or more interior layers to a BSR property for an anti-BSR layer refers to comparison of a level or value of the same BSR property unless stated differently.

Referring to FIG. 4B, a first component 100b that includes a plurality of additively manufactured interior layers 102 and a plurality additively manufactured anti-BSR layers 104 is shown. The plurality of additively manufactured interior layers 102 each, or as a whole, have a BSR property, and the plurality additively manufactured anti-BSR layers 104 each, or as a whole, have a corresponding BSR property that is different that the BSR property of the plurality of additively manufactured interior layers 102. And while only two anti-BSR layers 104 are shown in FIG. 4B, it should be understood that more than two anti-BSR layers 104 are included within the teachings of the present disclosure. For example, in some variations of the present disclosure, the two anti-BSR layers 104 shown in FIG. 4B, and other figures in the present disclosure, represent more than two anti-BSR layers 104.

Referring to FIG. 4C, a first component 100c that includes a plurality of additively manufactured interior layers 102 and a plurality additively manufactured anti-BSR layers 104a, 104b is shown. However, and unlike first component 100b shown in

FIG. 4B, the plurality additively manufactured anti-BSR layers 104a, 104b each have a different BSR property value. That is, the BSR property varies or is functionally graded across (Z direction) the plurality of additively manufactured anti-BSR layers 104a, 104b. As used herein, the term “functionally graded” refers to a monotonic change (e.g., monotonically increasing or monotonically decreasing) of a BSR property transversely across (Z direction) a plurality of additively manufactured interior layers and/or a plurality of additively manufactured anti-BSR layers.

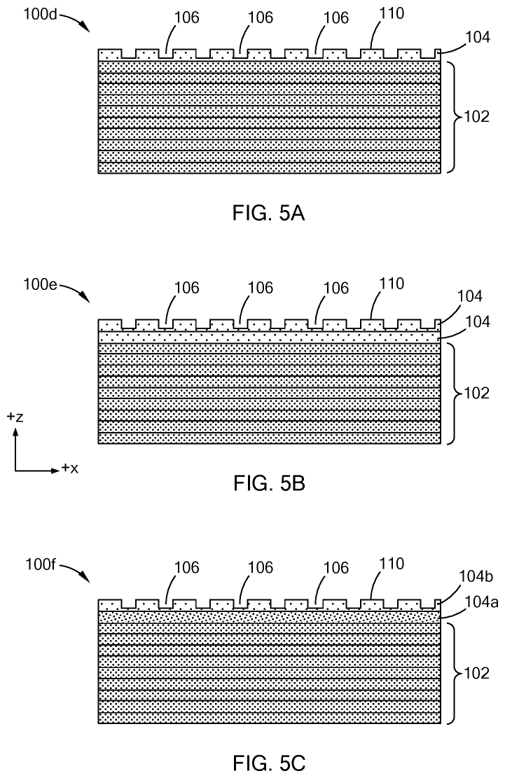

In some variations, one or more anti-BSR layers a geometric feature. For example, and with reference to FIGS. 5A-5C, FIG. 5A shows a first component 100d with a plurality of additively manufactured interior layers 102 and an additively manufactured anti-BSR layer 104 that includes one or more geometric features 106 along the surface 110. Non-limiting examples of the geometric features 106 include continuous grooves extending into (−z direction) the anti-BSR layer 104, slots extending into (−z direction) the anti-BSR layer 104, continuous channels or ribs extending from (+z direction) the anti-BSR layer 104, and buttons extending from (+z direction) the anti-BSR layer 104, among others.

Referring to FIG. 5B, a first component 100e with a plurality of additively manufactured interior layers 102 and a plurality of additively manufactured anti-BSR layers 104 is shown. In addition, at least one of the plurality of additively manufactured anti-BSR layers 104 includes one or more of geometric features 106 along the surface 110.

And referring to FIG. 5C, a first component 100f with a plurality of additively manufactured interior layers 102 and a plurality of functionally graded additively manufactured anti-BSR layer 104a, 104b is shown. In addition, at least the additively manufactured anti-BSR layer 104b includes one or more of the geometric features 106 along the surface 110.

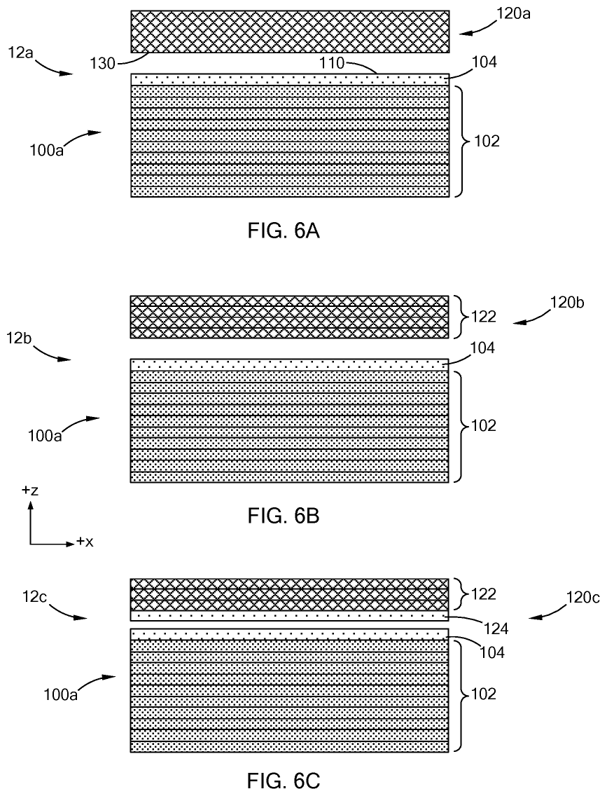

Referring to FIGS. 6A-6C, variations of a second component in a BSR application according to the teachings of the present disclosure are shown. For example, in FIG. 6A a BSR application 12a with the first component 100a and a second component 120a is shown. The first component 100a includes the plurality of interior layers 102 and the anti-BSR layer 104, and second component 120a is illustrated as a component made or formed using traditional manufacturing techniques. For example, the second component 120a is manufactured using techniques or processes such as extrusion, casting, machining, among others. It should be understood that the first component 100a with the anti-BSR layer 104 reduces BSR acoustic noise during use or operation of the first component 100a and the second component 120a in the BSR application 12a.

Referring to FIG. 6B, a BSR application 12b with the first component 100a and a second component 120b is shown. The first component 100a includes the plurality of interior layers 102 and the anti-BSR layer 104. In addition, the second component 120b is an additively manufactured component with a plurality of additively manufactured layers 122. It should be understood that the first component 100a with the anti-BSR layer 104 reduces BSR acoustic noise during use or operation of the first component 100a and the second component 120b in the BSR application 12b.

And referring to FIG. 6C, a BSR application 12c with the first component 100a and a second component 120c is shown. The first component 100a includes the plurality of interior layers 102 and the anti-BSR layer 104 and the second component 120c is an additively manufactured component with a plurality of additively manufactured layers 122 and at least one anti-BSR layer 124. It should be understood that the first component 100a with the anti-BSR layer 104 and the second component 120c with the anti-BSR layer 124 reduces BSR acoustic noise during use or operation of the first component 100a and the second component 120c in the BSR application 12c.

While FIGS. 6A-6C show BSR applications with the first component 100a, it should be understood that other first components (e.g., first components 100b-100f) in combination with the second components noted above are included within the scope of the present disclosure. In addition, it should be understood that a second component with a plurality of anti-BSR layers as described above with respect to FIGS. 4B-4C, a single anti-BSR layer with at least one geometric feature as described above with respect to FIG. 5A, and/or a plurality of anti-BSR layers with at least one geometric feature as described above with respect to FIG. 5B-5C.

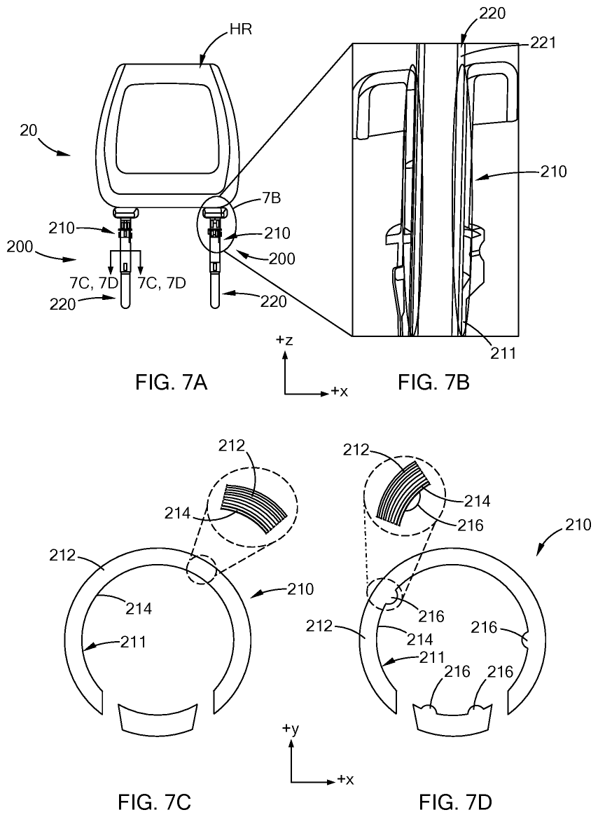

Referring now to FIGS. 7A-7D, one example of a BSR application 20 with a component having at least one anti-BSR layer is shown. The BSR application 20 includes a headrest ‘HR’ and a pair of headrest supports 200. It should be understood that the BSR application 20 occurs during use or operation of a vehicle that includes the headrest HR and the pair of headrest supports 200. Each of the headrest supports 200 include a first component 210 and a second component 220. In some variations, the first component 210 is a sleeve 210 and the second component 220 is a post 220 configured to fit and slide (z direction) within the sleeve 210. In addition, the headrest supports 200 are configured to support the headrest HR when the headrest HR is set or positioned at a number of different positions or orientations and thus it is desirable that the sleeve 210 and the post 220 are slidably relative to each other. However, a spacing between an inner surface 211 of the sleeve 210 and an outer surface 221 of the post 220 that allows for the sliding of the post 220 within the sleeve 210 can result in the BSR application 20. In some variations, the spacing between the inner surface 211 of the sleeve 210 and the outer surface 221 of the post 220 result in a bump or rattle BSR acoustic noise, e.g., due to vibration during movement of vehicle. In the alternative, or in addition to, the spacing between the inner surface 211 of the sleeve 210 and the outer surface 221 of the post 220 result in a squeak BSR noise. In addition, use of foam and/or felt tape between the inner surface 211 of the sleeve 210 and the outer surface 221 of the post 220 can be undesirable.

Referring particularly to FIG. 7C, in some variations the sleeve 210 includes a plurality of interior layers 212 and at least one anti-BSR layer 214 that includes the inner surface 211 and with a BSR property not equal to a corresponding BSR property of the plurality of interior layers 212. And referring particularly to FIG. 7D, in at least one variation, the sleeve 210 includes a plurality of interior layers 212, at least one anti-BSR layer 214 that includes the inner surface 211, and at least one geometric feature 216. It should be understood that the sleeve 210 with the anti-BSR layer 214 reduces BSR acoustic noise during use or operation of the sleeve 210 and the post 220 in the BSR application 20.

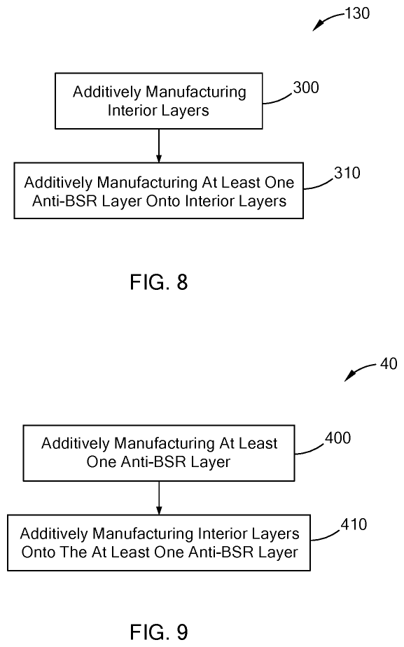

Referring to FIGS. 8 and 9, flow charts for methods 30 and 40, respectively, of manufacturing a component for a BSR application is shown. The method 30 includes additively manufacturing a plurality of interior layers at 300 and additively manufacturing at least one anti-BDR layer onto the plurality of interior layers at 310 to form the component. The method 40 includes additively manufacturing at least one anti-BSR layer at 400 and additively manufacturing a plurality of interior layers onto the at least one anti-BSR layer at 410 to form the component.

In some variations, the component is a multi jet fusion (MJF) additively manufactured component, i.e., plurality of interior layers and the at least one anti-BSR layer are MJF additive manufactured layers. And in such variations the at least one anti-BSR layer receives a different amount of thermal exposure than the plurality of interior layers during MJF AM of the component such that the at least one anti-BSR layer has a BSR property different than a corresponding BSR property of the plurality of interior layers. For example, in at least one variation the at least one anti-BSR layer receives less thermal exposure than the plurality of interior layers during MJF AM, and at least one of strength, ductility, hardness, elastic modulus, coefficient of friction, and density of the at least one anti-BSR layer is different than a corresponding strength, ductility, hardness, elastic modulus, coefficient of friction, and density of the plurality of interior layers.

In other variations, the component is a selective laser sintering (SLS) additive manufactured component, i.e., the plurality of interior layers and the at least one anti-BSR layer are selective laser sintering SLS additive manufactured layers. And in such variations the at least one anti-BSR layer receives a different amount of laser power than the plurality of interior layers during SLS AM of the component such that the at least one anti-BSR layer has a BSR property different than a corresponding BSR property of the plurality of interior layers. For example, in at least one variation the at least one anti-BSR layer receives less laser power or laser energy during SLS AM, and at least one of strength, ductility, hardness, elastic modulus, coefficient of friction, and density of the at least one anti-BSR layer is different than a corresponding strength, ductility, hardness, elastic modulus, coefficient of friction, and density of the plurality of interior layers.

In still other variations, the component is a continuous liquid interface production (CLIP), stereolithography (SLA) or digital light processing (DLP) additively manufactured component and the plurality of interior layers and the at least one anti-BSR layer are CLIP, SLA or DLP additive manufactured layers. And in such variations the at least one anti-BSR layer receives a different amount of ultraviolet energy than the plurality of interior layers during CLIP, SLA or DLP AM such that the at least one anti-BSR layer has a BSR property different than a corresponding BSR property of the plurality of interior layers. For example, in at least one variation the at least one anti-BSR layer receives a less ultraviolet energy than the plurality of interior layers during CLIP, SLA or DLP AM, and at least one of strength, ductility, hardness, elastic modulus, coefficient of friction, and density of the at least one anti-BSR layer is different than a corresponding strength, ductility, hardness, elastic modulus, coefficient of friction, and density of the plurality of interior layers.

In yet still other variations, the component is a fused filament fabrication (FFF) additively manufactured component, i.e., the plurality of interior layers and the at least one anti-BSR layer are FFF additive manufactured layers. And in such variations the at least one anti-BSR layer is FFF additive manufactured with a different extruded temperature, cooling rate, bead width and/or a different contour than the plurality of interior layers during FFF AM such that the at least one anti-BSR layer has a BSR property different than a corresponding BSR property of the plurality of interior layers. For example, in at least one variation the at least one anti-BSR layer is formed with a bead width that is greater than a bead width of the plurality of interior layers during FFF AM, and at least one of strength, ductility, hardness, elastic modulus, coefficient of friction, and density of the at least one anti-BSR layer is different than a corresponding strength, ductility, hardness, elastic modulus, coefficient of friction, and density of the plurality of interior layers.

It should be understood that control of the thermal exposure, laser power, ultraviolet exposure, extruded temperature, cooling rate, bead width and bead contour as described above provides for control on the voxel level and can be executed or adjusted via G-Code for a given AM operation. As used herein the term “voxel” refers to a unit of graphic information that defines a point in three-dimensional space and the term “G-Code” refers to programming language used to control AM machines (printers).

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of manufacturing a component, the method comprising:
additively manufacturing (AM) a plurality of interior layers of the component and AM at least one anti-BSR layer of the component, wherein the at least one anti-BSR layer is configured to reduce BSR acoustic noise compared to the plurality of interior layers.

2. The method according to claim 1, wherein the at least one anti-BSR layer is a plurality of anti-BSR layers, and the plurality of anti-BSR layers comprises a BSR property different than a corresponding BSR property of the plurality of interior layers.

3. The method according to claim 2, wherein the BSR property of the plurality of anti-BSR layers is generally uniform across the plurality of anti-BSR layers.

4. The method according to claim 2, wherein the BSR property of the plurality of anti-BSR layers is functionally graded across the plurality of anti-BSR layers.

5. The method according to claim 2, wherein the BSR property of the plurality of anti-BSR layers and the corresponding BSR property of the plurality of interior layers is selected from the group consisting of strength, ductility, hardness, elastic modulus, coefficient of friction, and density.

6. The method according to claim 1, wherein the plurality of interior layers of the component and the at least one anti-BSR layer are multi jet fusion (MJF) additive manufactured layers and the at least one anti-BSR layer receives less thermal exposure than the plurality of interior layers during MJF AM of the component such that the at least one anti-BSR layer comprises a BSR property different than a corresponding BSR property of the plurality of interior layers, wherein the BSR property of the at least one anti-BSR layer and the corresponding BSR property of the plurality of interior layers is selected from the group consisting of strength, ductility, hardness, elastic modulus, coefficient of friction, and density.

7. The method according to claim 1, wherein the plurality of interior layers and the at least one anti-BSR layer are selective laser sintering (SLS) additive manufactured layers and the at least one anti-BSR layer is formed with less laser power than the plurality of interior layers during SLS AM of the component such that the at least one anti-BSR layer comprises a BSR property different than a corresponding BSR property of the plurality of interior layers.

8. The method according to claim 7, wherein the BSR property of the at least one anti-BSR layer and the corresponding BSR property of the plurality of interior layers is selected from the group consisting of strength, ductility, hardness, elastic modulus, coefficient of friction, and density.

9. The method according to claim 1, wherein the plurality of interior layers and the at least one anti-BSR layer are continuous liquid interface production (CLIP) or stereolithography (SLA) additive manufactured layers and the at least one anti-BSR layer is formed with less ultraviolet energy than the plurality of interior layers during CLIP or SLA AM of the component such that the at least one anti-BSR layer comprises a BSR property different than a corresponding BSR property of the plurality of interior layers.

10. The method according to claim 9, wherein the BSR property of the at least one anti-BSR layer and the corresponding BSR property of the plurality of interior layers is selected from the group consisting of strength, ductility, hardness, elastic modulus, coefficient of friction, and density.

11. The method according to claim 1, wherein the plurality of interior layers and the at least one anti-BSR layer are fused filament fabrication (FFF) additive manufactured layers and the at least one anti-BSR layer is formed with at least one of an extruded temperature and a cooling rate that is different than the extruded temperature and the cooling rate, respectively, than the plurality of interior layers during FFF AM of the component such that the at least one anti-BSR layer comprises a BSR property different than a corresponding BSR property of the plurality of interior layers.

12. The method according to claim 11, wherein the BSR property of the at least one anti-BSR layer and the corresponding BSR property of the plurality of interior layers is selected from the group consisting of strength, ductility, hardness, elastic modulus, coefficient of friction, and density.

13. The method according to claim 1, wherein the at least one anti-BSR layer has a first ductility, the plurality of interior layers have a second ductility less than the first ductility, and the at least one anti-BSR layer is configured as an anti-bump and anti-rattle layer.

14. The method according to claim 1, wherein the at least one anti-BSR layer has a first coefficient of friction, the plurality of interior layers have a second coefficient of friction greater than the first coefficient of friction, and the at least one anti-BSR layer is configured as an anti-squeak layer.

15. The method according to claim 1, wherein the at least one anti-BSR layer has a first density, the plurality of interior layers have a second density less than the first density, and the at least one anti-BSR layer is configured as at least one of an anti-bump layer, an anti-rattle layer, and an anti-squeak layer.

16. A method of manufacturing a component, the method comprising:
additively manufacturing (AM) a plurality of interior layers of the component and AM a plurality of anti-BSR layers of the component, wherein the plurality of anti-BSR layers comprises a BSR property different than a corresponding BSR property of the plurality of interior layers such that the plurality of anti-BSR layers is configured to reduce BSR acoustic noise compared to the plurality of interior layers.

17. The method according to claim 16, wherein the plurality of anti-BSR layers has a first ductility, the plurality of interior layers have a second ductility less than the first ductility, and the plurality of anti-BSR layers is configured as an anti-bump and anti-rattle layer.

18. The method according to claim 16, wherein the plurality of anti-BSR layers has a first coefficient of friction, the plurality of interior layers have a second coefficient of friction greater than the first coefficient of friction, and the plurality of anti-BSR layers is configured as an anti-squeak layer.

19. A method of manufacturing a component, the method comprising:
additively manufacturing (AM) a plurality of interior layers of the component and AM a plurality of anti-BSR layers of the component, wherein the plurality of anti-BSR layers comprises a BSR property different than a corresponding BSR property of the plurality of interior layers such that the plurality of anti-BSR layers is configured to reduce BSR acoustic noise compared to the plurality of interior layers, and the BSR property of the plurality of anti-BSR layers and the corresponding BSR property of the plurality of interior layers is selected from the group consisting of strength, ductility, hardness, elastic modulus, coefficient of friction, and density.

20. The method according to claim 19, wherein the plurality of anti-BSR layers is formed with at least one of less ultraviolet energy, less thermal exposure, less laser power, and a slower cooling rate than the plurality of interior layers.
